(19) United States
(12) Patent Application Publication
(10) Pub. No.: US 2010/0152313 A1
(43) Pub. Date: Jun. 17, 2010

(54) PROCESS FOR PREPARATION OF HIGH-MOLECULAR-WEIGHT POLYAMIDES

(75) Inventors: Peter Eibeck, Ludwigshafen (DE); Volker Warzelhan, Weisenheim (DE); Bernd Bruchmann, Freinsheim (DE)

Correspondence Address: Connolly Bove Lodge & Hutz LLP, 1875 Eye Street, NW, Suite 1100, Washington, DC, 20006, US

(73) Assignee: BASF SE, Ludwigshafen (DE)

(21) Appl. No.: 12/711,313

(22) Filed: Feb. 24, 2010

Related U.S. Application Data
(63) Continuation of application No. 11/659,285, filed on Feb. 2, 2007.

(30) Foreign Application Priority Data
Aug. 4, 2004 (DE) 102004038014.7

(51) Int. Cl. C08G 69/28; C08G 69/48

(52) U.S. Cl. 521/184; 525/420; 525/431

(57) ABSTRACT

Process for preparation of high-molecular-weight polyamides, which comprises reacting a polyamide A) at a temperature of from 150 to 350° C. with a compound B) which at this reaction temperature liberates isocyanic acid, where the concentration of the amino end groups in the polyamide A) used is greater than or equal to the concentration of the carboxy end groups.

The invention relates to a process for preparation of high-molecular-weight polyamides, which comprises reacting a polyamide A) at a temperature of from 150 to 350° C. with a compound B) which at this reaction temperature liberates isocyanic acid, where the concentration of the amino end groups in the polyamide A) used is greater than or equal to the concentration of the carboxy end groups.

The invention further relates to the high-molecular-weight polyamides obtainable by the process, to their use for production of moldings, foils, fibers, or foams, and also to the moldings, foils, fibers, or foams composed of the high-molecular-weight polyamides. Finally, a process has been found for increasing the molecular weight of polyamides, which comprises reacting a polyamide A) in which the concentration of the amino end groups is greater than or equal to the concentration of the carboxy end groups, at a temperature of from 150 to 350° C., with a compound B) which at this reaction temperature liberates isocyanic acid.

High-molecular-weight polyamides have high melt viscosities and are in particular used for extrusion of semifinished products, e.g. profiles, sheets, or bars, and for blown foils. In these processes, the high melt viscosity has a favorable effect on processability and on the quality of the resultant products. Prior-art processes, see by way of example DE-A 3923061, prepare high-molecular-weight polyamides in two stages: first, the monomers are used in, by way of example, a melt condensation process to prepare a low-molecular-weight polymer, and this is then reacted to give the high-molecular-weight final product in a solid-phase condensation process.

This two-stage polymerization is inconvenient, and it would be advantageous to circumvent the solid-phase condensation process. Ideally, the molecular weight increase should be obtainable simply by adding, to the low-molecular-weight polyamide, an additive which rapidly brings about the desired molecular weight increase.

WO 02/26865 describes a process for reducing e-caprolactam content in nylon-6 (PA 6), by adding, either a) to the polymerization process for the PA 6 or b) to a PA 6 melt, an additive which forms isocyanic acid when heated, e.g. urea. In most of the examples, the urea is added toward the end of the polymerization process; in example 15, a commercially available pelletized PA 6 is sprayed with a urea solution and dried, and extruded at from 240 to 260° C. The relative solution viscosity of the urea-treated polyamides is not significantly different from that of the non-urea-containing comparative examples, and the specification lacks any kind of indication of an increase in molecular weight. No information is given concerning the amino end group concentration or carboxy end group concentration in the polyamide prior to addition of the urea.

It was an object to eliminate the disadvantages described. The intention was to provide an alternate process for preparation of high-molecular-weight polyamides. Its design should preferably be simpler than that of the prior-art processes. In particular, the process should not require any solid-phase condensation.

Ideally, the desired molecular weight increase should be achieved simply via addition of an additive to a conventional polyamide which does not have high molecular weight.

Accordingly, the following have been found: the process mentioned at the outset for preparation of high-molecular-weight polyamides, the polyamides obtainable thereby, their use for production of moldings, foils, fibers, or films, and the moldings, foils, fibers, and films composed of the polyamides. The process mentioned at the outset for increasing the molecular weight of the polyamides has also been found.

Component A): Polyamides

The inventive process for preparation of high-molecular-weight polyamides reacts a polyamide A) at from 150 to 350° C. with a compound B) which liberates isocyanic acid at this reaction temperature. According to the invention, the concentration of the amino end groups (AEC, amino end group concentration) in the polyamide A) used is greater than or equal to the concentration of the carboxy end groups (CEC, carboxy end group concentration), i.e. AEC≧CEC.

The amino end group concentration is preferably greater than the carboxy end group concentration, i.e. AEC>CEC.

The abovementioned concentrations are defined in the usual way as number of end groups (in units of mol or equivalent) per unit by weight of polyamide, e.g. x mmol of end groups per kg of polyamide.

By way of example, the amino end groups may be determined by means of titration of a solution of the polyamide in the presence of an indicator. For this, the polyamide A) is dissolved, with heating, in a mixture composed of phenol and methanol (e.g. 75% by weight of phenol and 25% by weight of methanol). By way of example, the mixture may be kept at reflux at boiling point until the polymer has dissolved. The cooled solution is treated with a suitable indicator or with an indicator mixture (e.g. methanolic solution of benzyl orange and methylene blue) and is titrated with a methanol-containing solution of perchloric acid in glycol until the color changes. The amino end group concentration is calculated from the consumption of perchloric acid.

As an alternative, the titration may also be carried out potentiometrically, without indicator, using a solution of perchloric acid in ethylene glycol, as described on page 11 of WO 02/26865.

By way of example, the carboxy end groups may also be determined via titration of a solution of the polyamide, using an indicator. For this, the polyamide A) is dissolved in benzyl alcohol (phenylmethanol) with heating, e.g. to the boiling point, under a vertical condenser and with nitrogen gas input. While still hot, the solution is then treated with a suitable indicator (e.g. a propanolic solution of kresol red), and then titrated immediately with an alcoholic potassium hydroxide solution (KOH dissolved in a mixture composed of methanol, 1-propanol, and 1-hexanol) until color-change occurs. The carboxy end group concentration is calculated from the consumption of KOH.

As an alternative, the titration may also be carried out conductometrically, without indicator, using a solution of NaOH in benzyl alcohol, as described on pp. 11-12 of WO 02/26865.

Suitable polyamides A) are in principle any of the known polyamides which comply with the condition AEC≧CEC. By way of example, use may be made of polyamides with aliphatic semicrystalline or semiaromatic or amorphous structure, of any type, or of blends of these, among which are polyetheramides, such as polyether block amides.

Semicrystalline or amorphous resins with a molecular weight (weight-average) of at least 5000, e.g. those described in the American patent specifications U.S. Pat. Nos. 2,071,250, 2,071,251, 2,130,523, 2,130,948, 2,241,322, 2,312,966, 2,512,606 and 3,393,210 are preferred. Examples of these are polyamides derived from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. Acids which may be mentioned here are adipic acid, azelaic acid, sebacic acid, dodecanedioic acid (=decanedicarboxylic acid) and terephthalic and/or isophthalic acid.

Particularly suitable diamines are alkanediamines having from 6 to 12, in particular from 6 to 8, carbon atoms, and also m-xylylenediamine, di(4-aminophenyl)methane, di(4-aminocyclohexyl)methane, di(4-amino-3-methylcyclohexyl)methane, isophoronediamine, 1,5-diamino-2-methylpentane, 2,2-di(4-aminophenyl)propane, or 2,2-di(4-aminocyclohexyl)propane.

Preferred polyamides are polyhexamethyleneadipamide (PA 66) and polyhexamethylenesebacamide (PA 610), polycaprolactam (PA 6), and also nylon-6/66 copolyamides, in particular having a proportion of from 5 to 95% by weight of caprolactam units. PA 6, PA 66, and nylon-6/66 copolyamides are particularly preferred; PA 6 is very particularly preferred.

Other suitable polyamides are obtainable from w-aminoalkyl nitriles, e.g. aminocapronitrile (PA 6) and adipodinitrile with hexamethylenediamine (PA 66) via what is known as direct polymerization in the presence of water, for example as described in DE-A 10313681, EP-A 1198491 and EP-A 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio.

Other polyamides which have proven particularly advantageous are semiaromatic copolyamides, such as PA 6/6T and PA 66/6T, where the triamine content of these is less than 0.5% by weight, preferably less than 0.3% by weight (see EP-A 299 444). The processes described in EP-A 129 195 and 129 196 can be used to prepare the semiaromatic copolyamides with low triamine content.

The following list, which is not comprehensive, comprises the polyamides A) mentioned and other polyamides A) for the purposes of the invention, and the monomers present:

AB Polymers:

| | |
|---|---|
| PA 6 | ∈-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |

AA/BB Polymers:

| | |
|---|---|
| PA 46 | Tetramethylenediamine, adipic acid |
| PA 66 | Hexamethylenediamine, adipic acid |
| PA 69 | Hexamethylenediamine, azelaic acid |
| PA 610 | Hexamethylenediamine, sebacic acid |
| PA 612 | Hexamethylenediamine, decanedicarboxylic acid |
| PA 613 | Hexamethylenediamine, undecanedicarboxylic acid |
| PA 1212 | 1,12-Dodecanediamine, decanedicarboxylic acid |
| PA 1313 | 1,13-Diaminotridecane, undecanedicarboxylic acid |
| PA 6T | Hexamethylenediamine, terephthalic acid |
| PA MXD6 | m-Xylylenediamine, adipic acid |
| PA 6I | Hexamethylenediamine, isophthalic acid |
| PA 6-3-T | Trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 12 | Diaminodicyclohexylmethane, laurolactam |
| PA 6I/6T/PACM | as PA 6I/6T + diaminodicyclohexylmethane |
| PA 12/MACMI | Laurolactam, dimethyldiaminodicyclohexylmethane, |
| | isophthalic acid |
| PA 12/MACMT | Laurolactam, dimethyldiaminodicyclohexylmethane, |
| | terephthalic acid |
| PA PDA-T | Phenylenediamine, terephthalic acid |

These polyamides A) and their preparation are known, for example from Ullmanns Encyklopädie der Technischen Chemie [Ullmanns Encyclopedia of Industrial Chemistry], 4th edition, vol. 19, pp. 39-54, Verlag Chemie, Weinheim 1980; Ullmanns Encyclopedia of Industrial Chemistry, Vol. A21, pp. 179-206, VCH Verlag, Weinheim 1992; Stoeckhert, Kunststofflexikon [Plastics Encyclopedia], 8th edition, pp. 425-428, Carl Hanser Verlag Munich 1992 (key word “Polyamides” et seq.) and Saechtling, Kunststoff-Taschenbuch [Plastics Handbook], 27th edition, Carl Hanser-Verlag Munich 1998, pp. 465-478.

Brief details are given below of the preparation of the preferred polyamides PA6, PA 66, and nylon-6/66 copolyamide.

The polymerization or polycondensation of the starting monomers to give the polyimide A) is preferably carried out by the usual processes. For example, caprolactam may be polymerized by the continuous processes described in DE-A 14 95 198 and DE-A 25 58 480. The polymerization of AH salt to prepare PA 66 may be carried out by the usual batch processes (see: Polymerization Processes pp. 424-467, in particular pp. 444-446, Interscience, New York,1977) or by a continuous process, e.g. as in EP-A 129 196.

Concomitant use may be made of conventional chain regulators during the polymerization process. Examples of suitable chain regulators are triacetonediamine compounds (see WO-A 95/28443), and bases, in particular amines. Bases are preferred as chain regulators, because when they are used it is easy to establish the required equivalence or excess of amino end groups (AEC CEC). Examples of suitable bases are hexamethylenediamine, bis(hexamethylene)triamine, benzylamine, 1,4-cyclohexanediamine, bis(tetramethylene)triamine, 4-aminomethyl-1,8-octanediamine, tris(3-aminopropyl)amine, N,N,N′,N′-tetra(3-aminopropyl)ethylenediamine, and the diamines mentioned at an earlier stage above.

If use is made of chain regulators, their amount is generally from 0.01 to 5% by weight, in particular from 0.1 to 1.5% by weight, based on the monomers used during the preparation of the polyamide A).

The polymer melt obtained is discharged from the reactor, cooled, and pelletized. The resultant pellets can be subjected to continued polymerization. This takes place in a manner known per se, via heating of the pellets to a temperature T below the melting point Tₘ or crystallite melting point T_{c} of the polyamide. The continued polymerization establishes the final molecular weight of the polyamide (measurable as viscosity number VN, see VN information at a later stage below). The continued polymerization, if required, usually takes from 2 to 24 hours, in particular from 12 to 24 hours. Once the desired molecular weight of the polyamide A) has been reached, the pellets are cooled in the usual way.

The form in which the polyamide A) is used may be that of chipped or chopped material, or some other usual form, instead of pellets. If appropriate, the polyamide A) is dried to give a water content of from 0.01 to 0.1% by weight, based on the polyamide A). To this end, use may be made of usual drying apparatus, e.g. drying in vacuo and/or at an elevated temperature.

The method of preparation of the polyamides A) is generally non-critical. All that has to be ensured is that the amino end group concentration is greater than or equal to the carboxy end group concentration in the polyamide A) used.

The viscosity number VN of suitable polyamides A) is generally from 50 to 200 ml/g, preferably from 70 to 160 ml/g, and particularly preferably from 90 to 130 ml/g, determined to ISO 307 EN on a 0.5% strength by weight solution of the polyamide in 96% strength by weight sulfuric acid at 25° C.

The molecular weights corresponding to these viscosity numbers are usual and high molecular weights. The inventive process can therefore use not only polyamides A) with usual molecular weight but also high-molecular-weight polyamides A), and can further increase the molecular weight of these materials.

It has been found that the molecular weight of the polyamide A) can be increased particularly easily and rapidly if at least a portion of the polymer chains of the polyamide A) has two or more amino end groups. One preferred embodiment is a process wherein at least 20 mol% of the polymer chains in the polyamide A) have two or more amino end groups. This proportion is particularly preferably at least 30 mol%.

Component 8): Compounds Liberating Isocyanic Acid

Suitable compounds B) are any of the compounds which liberate isocyanic acid at from 150 to 350° C. Examples of this source of isocyanic acid are urea, condensates of urea, such as biuret, triuret, or cyanuric acid, and other urea derivatives and oligomeric or polymeric urea compounds which liberate isocyanic acid at the reaction temperature mentioned. These compounds are in particular carbamates, such as silyl carbamate, trimethylsilyl carbamate, and trimethylsilylurea or poly(nonamethylene)urea.

The compound B) has preferably been selected from urea, biuret, triuret, cyanuric acid, silyl carbamate, trimethylsilyl carbamate, trimethylsilylurea, and poly(nonamethylene)urea. It is particularly preferable to use urea, biuret, triuret, or cyanuric acid, in particular urea.

The compound B) may be reacted as it stands with the polyamide A), the temperature mentioned producing the isocyanic acid during the reaction. This is preferred. As an alternative, the isocyanic acid may first be prepared separately from the sources mentioned of isocyanic acid (e.g. ureas, biuret, triuret, cyanuric acid, carbamates) via thermal decomposition, and this separately prepared isocyanic acid may then be reacted with the polyamide A). The method of initiating the thermal decomposition of the source of isocyanic acid may be heating, or else introduction of energy by way of electromagnetic radiation.

The amount of the compound B), based in each case on the entirety of components A) and B), is generally from 0.001 to 10% by weight, preferably from 0.01 to 3% by weight, particularly preferably from 0.05 to 2% by weight, and in particular from 0.1 to 1% by weight.

The amount particularly preferably used of compound B) is such that the molar ratio of compound B) to the amino end groups of the polyamide A) is from 0.2:1 to 2:1, in particular from 0.3:1 to 1.5:1, and particularly preferably from 0.5:1 to 0.8:1. If 1 mol of the compound B) liberates more than 1 mol of isocyanic acid, the amount of compound B) to be used is correspondingly less, and this means that the molar ratio mentioned is strictly based on the isocyanic acid liberated from the compound B).

The compounds B) are commercially available, or are compounds whose preparation is known to the person skilled in the art.

The compound B) may be used as it stands or dissolved or suspended in a suitable solvent or suspension medium. Examples of suitable solvents are alcohols having from 1 to 10 carbon atoms, in particular methanol, ethanol, or the propanols.

Optional Component C): Copper Compounds

It has been found that the inventive process gives a particularly marked increase in the molecular weight of the polyamide if concomitant use is made of copper compounds C). They are therefore used concomitantly in particular if the intention is to prepare polyamides with particularly high molecular weight.

The process is therefore preferably one wherein concomitant use is made of a copper compound C) in addition to components A) and B).

Particularly suitable copper compounds C) are those of mono- or divalent copper. Examples of suitable compounds are the salts of mono- or divalent copper with inorganic or organic acids or with mono- or polyhydric phenols, the oxides of mono- or divalent copper, or the complexes of copper salts with ammonia, with amines, with amides, with lactams, with cyanides, or with phosphines. It is preferable to use the Cu(I) and Cu(II) salts of the hydrohalic acids, or of hydrocyanic acid, or the copper salts of the aliphatic carboxylic acids. Particularly preference is given to the monovalent copper compounds CuCl, CuBr, CuI, CuCN and Cu₂O, and also the divalent copper compounds CuCl₂, CuSO₄, CuO, copper(II) acetate or copper(II) stearate.

If concomitant use is made of a copper compound C), its amount is from 0.001 to 1% by weight, preferably from 0.005 to 0.5% by weight, in particular from 0.005 to 0.3% by weight, and particularly preferably from 0.01 to 0.2% by weight, based on the entirety of components A), B), and C).

The copper compounds C) are commercially available, or are compounds whose preparation is known to the person skilled in the art.

The copper compound C) may be used as it stands, or preferably in the form of concentrates. A concentrate is a polymer which comprises a large amount of the copper compound, for example from 1 to 30% by weight, based on the concentrate. The chemical nature of the polymer is preferably identical or similar to that of the polyamide A), and the polymer is therefore preferably likewise a polyamide. The use of concentrates is a usual process, in particular for metering small amounts of a starting material into a polymer.

Use may also be made, of course, of mixtures of two or more polyamides A), compounds B) liberating isocyanic acid, and, if appropriate, copper compounds C). In this case, the stated amounts for component B) and C) are based on the entirety of all of the components B′), B″), etc. and, respectively, C′), C″), etc.

Other Components

Particular other components which may be used are additives and, respectively, processing aids usually used in polymers or during their preparation. The amounts required vary, depending on the additive or auxiliary, and depend in a known manner, inter alia, on the intended use of the high-molecular-weight polyamide. See, for example, Gächter/Müller, Plastics Additives Handbook, 4th ed., Hanser-Verlag Munich 1993, reprint November 1996

The additives and auxiliaries may be used concomitantly either during the inventive process, i.e. during the preparation of the high-molecular-weight polyamide from components A), B), and, if appropriate, C), or the additives and processing aids may be added in a subsequent step (known as compounding) to the high-molecular-weight polyamide after its preparation.

Examples of suitable additives or processing aids are lubricants or mold-release agents, rubbers, antioxidants, light stabilizers, antistatic agents, flame retardants, fibrous or pulverulent fillers, fibrous or pulverulent reinforcing agents, nucleating agents, organic or inorganic colorants (dyes or pigments), and other additives, and mixtures of these.

Examples of suitable lubricants and mold-release agents are stearic acids, stearyl alcohol, stearic esters, stearamides, silicone oils, metal stearates, montan waxes, and those based on polyethylene and polypropylene.

Examples of suitable antioxidants (heat stabilizers) are sterically hindered phenols, hydroquinones, arylamines, phosphites, various substituted members of this group, and also mixtures of these. By way of example, they are commercially available as Topanol®, Irgafos®, Irganox®, or Naugard®. The copper compounds C), too, may act as antioxidants, in particular together with metal halides, preferably alkali metal halides, e.g. NaI, KI, NaBr, or KBr.

Examples of suitable light stabilizers are various substituted resorcinols, salicylates, benzotriazoles, benzophenones, HALS (Hindered Amine Light Stabilizers), e.g. those available commercially as Tinuvin®.

Examples of suitable antistatic agents are amine derivatives, such as N,N-bis(hydroxyalkyl)alkylamines or -alkyleneamines, polyethylene glycol esters, or glycerol mono- or distearates, and also mixtures of these.

Examples of suitable flame retardants are the halogen-containing or phosphorus-containing compounds known to the person skilled in the art, magnesium hydroxide, red phosphorus, and other familiar compounds, and mixtures of these.

Examples which may be mentioned of fibrous or pulverulent fillers and fibrous of pulverulent reinforcing materials are carbon fibers or glass fibers in the form of glass fabric, glass mats, or glass silk rovings, chopped glass, glass beads, and wollastonite, particularly preferably glass fibers. If glass fibers are used, these may have been treated with a size and with a coupling agent to improve compatibility with the components of the blend. The glass fibers incorporated may take the form of short glass fibers or else that of continuous-filament strands (rovings).

Examples of suitable particulate fillers are carbon black, amorphous silica, magnesium carbonate, calcium carbonate, chalk, powdered quartz, mica, bentonites, talc, feldspar, or in particular calcium silicates, such as wollastonite, and kaolin.

Examples of suitable nucleating agents are talc, carbon black, polyamides with higher melting point than component A), fluoropolymers, such as polytetrafluoroethylene (PTFE), titanium dioxide, calcium phenylphosphinate, aluminum oxide, magnesium oxide, and other metal oxides or metal carbonates.

Colorants which may be used are any of the organic or inorganic dyes and, respectively, pigments which are suitable for coloring polymers, see by way of example Plastics Additives Handbook, pp. 637-708.

Reaction of the Components

According to the invention, the polyamide A) is reacted with the compound B) liberating isocyanic acid and, if appropriate, with the copper compound C) at from 150 to 350° C. The selection of the reaction temperature within this range here is to be such that the compound B) liberates isocyanic acid, and this means that the required minimum temperature depends, inter alias, on the compound B).

The reaction preferably takes place in a melt of the polyamide A), and the lower temperature limit in this case is also a function of the softening point of the polyamide. The upper temperature limit is generally determined via the thermal stability of the polyamide, and the selection of the temperature is usually such as to avoid thermal degradation of the polyamide. The reaction temperature is preferably from 200 to 300° C., particularly preferably from 240 to 280° C.

The pressure prevailing during the reaction is usually non-critical.

The inventive process may be carried out batchwise or continuously. Usual mixing apparatus, such as mixers, kneaders, or—preferably—extruders are suitable for this purpose. They are usually temperature-controllable in order to set the temperature required for the reaction, and a portion of the thermal energy here is often produced simply by the shear associated with the mixing procedure, the remaining portion being introduced via heating of the mixing apparatus.

Particularly suitable mixers are mixers with moving implements, e.g. ribbon mixers, twin-helix mixers, paddle mixers, plowshare mixers, low- or high-speed trough mixers, conical-screw mixers, silo vertical screw mixers, agitator mixers (including planetary agitator mixers), or roll mills, with batchwise or continuous operation, depending on the design.

Examples of suitable kneaders are internal mixers and trough kneaders (including twin-blade kneaders).

Extruders which may be used comprise any of the usual screw-based machinery, in particular single-screw and twin-screw extruders (e.g. ZSK from Coperion or Werner & Pfleiderer), co-kneaders, Kombiplast machinery, MPC kneading mixers, FCM mixers, KEX kneading screw extruders, and shear-roll extruders. The reaction preferably takes place in an extruder.

Details concerning the mixing apparatus mentioned and other, likewise suitable, mixing apparatus are given by way of example by Saechtling on pp. 202-250 of the Kunststoff-Taschenbuch [Plastics Handbook] mentioned.

The mixing apparatus and its design, in particular the nature and rotation rate of the mixing implement, and the amounts introduced, and the throughput of the mixing apparatus are selected in a known manner in such a way that the compound B) liberates isocyanic acid and this, and, if appropriate, also the copper compound C), can react with the polyamide A). In the case of the extruder, by way of example, the rotation rate, length, diameter, and design of the extruder screw(s) (e.g. number of flights and depth of flights, pitch, sequence of conveying, kneading, and mixing elements along the screw) may be varied appropriately.

The reaction time is generally from 10 sec to 60 min, preferably from 20 sec to 30 min, and in particular from 25 sec to 10 min. In the case of continuous mixing apparatus, the reaction time is the average residence time, for example in the extruder.

Components A), B), and, if appropriate, C) may first be premixed “cold”, and this mixture may be introduced into the mixing apparatus in which the reaction takes place at the reaction temperature. By way of example, the compound B) may be applied to the solid polyamide A), and the resultant treated polyamide may be mixed in the extruder at the reaction temperature, if appropriate together with the copper compound C), and the mixture may be extruded. This embodiment is preferred.

In this embodiment, the application of the compound B) to the polyamide A) may, by way of example, take place via spraying of the polyamide pellets with a solution or suspension of the compound B), or via application of this solution or suspension to the polyamide A) in a drum. Examples of suitable solutions of B) are an alcoholic solution, e.g. in ethanol. Once the solvent has been removed (e.g. in vacuo and/or at an elevated temperature), the polyamide pellets treated with compound B) are introduced into the extruder, if appropriate together with the copper compound C), where the reaction takes place.

As an alternative, some of the components may be introduced into the mixing apparatus and heated to the reaction temperature, and the remaining components may be metered directly into the mixing apparatus. By way of example, the polyamide A) may first be melted in the extruder or in another mixing apparatus, and components B) and, if appropriate, C) may be metered directly into the extruder. It is also possible to introduce all of the components separately from each other into the mixing apparatus. If concomitant use is made of a copper compound C), it is preferably introduced into the mixing apparatus prior to or together with the compound B).

In all cases, the product obtained comprises a high-molecular-weight polyamide. The high-molecular-weight polyamide drawn off from the mixing apparatus is generally molten. It is solidified in the usual way, for example passed through a water bath, and pelletized or otherwise comminuted.

As mentioned, the usual additives or processing aids mentioned may be introduced either during the preparation of the high-molecular-weight polyamide or in a downstream compounding step.

The inventive process is preferably one wherein the viscosity number (VN) of the resultant high-molecular-weight polyamide is from 120 to 400 ml/g, determined to ISO 307 EN on a 0.5% strength by weight solution of the polyamide in 96% strength by weight sulfuric acid at 25° C. The viscosity number is particularly preferably from 150 to 350 ml/g, in particular from 180 to 320 ml/g.

The process is also preferably one wherein the high-molecular-weight polyamide contains volatile bases (VBs). The concentration of the volatile bases depends, by way of example, on the carboxy end group concentration of the polyamide A) and on the amount used of compound B) and is preferably at least 1 mmol of VB per kg of high-molecular-weight polyamide.

By way of example, the volatile bases may be determined by means of acidic hydrolysis of the high-molecular-weight polyamide, liberation of the bases via addition of a strong base, distillation of the liberated bases over into a receiver comprising an acidic material, and back-titration of the excess receiver acid in the presence of an indicator. In an example of a method for this, the high-molecular-weight polyamide is first hydrolyzed via boiling with hydrochloric acid under a vertical condenser. Once the mixture has been cooled, the vertical condenser is replaced by a dropping funnel and distillation bridge, an excess of NaOH is added dropwise, and the bases liberated are distilled over into a receiver, where they are absorbed by an excess of hydrochloric acid. The excess hydrochloric acid in the receiver is then back-titrated with NaOH and bromokresol red as indicator, and the concentration of free base is calculated from the consumption of NaOH.

The invention provides not only the process for preparation of the high-molecular-weight polyamide, but also the high-molecular-weight polyamide obtainable by this process.

The high-molecular-weight polyamide may be used as it stands, or after blending with other polymers, i.e. in a polymer blend. These other polymers are in particular conventional polyamides (see description of component A)), and rubber polymers, which impact-modify the polyamide. Particularly suitable rubber polymers are diene rubbers, such as polybutadiene or styrene-butadiene copolymers, acrylate rubbers, such as poly-n-butyl acrylate, ethylene rubbers, such as EPM and EPDM (ethylene-propylene(diene) monomer), and silicone rubbers. The rubber may also have the structure of a core-shell rubber (graft rubber), of a random copolymer rubber, or of a block copolymer rubber.

From the high-molecular-weight polyamide it is possible to produce moldings of any type, foils, fibers (among which are filaments and monofils) and foams. The invention therefore also provides the use of the high-molecular-weight polyamides for production of moldings, foils, fibers, or foams, and the moldings, foils, fibers, or foams composed of the high-molecular-weight polyamides.

The inventive preparation process for high-molecular-weight polyamides is simpler than the prior-art processes, and does not require complicated solid-phase condensation. The desired molecular weight increase is achieved in a particularly problem-free manner via simple addition, to a conventional polyamide not of high molecular weight, of urea or of another compound liberating isocyanic acid.

The invention also provides a process (“increase process”) for increasing the molecular weight of polyamides, which comprises reacting a polyamide A) in which the concentration of the amino end groups is greater than or equal to the concentration of the carboxy end groups, at a temperature of from 150 to 350° C., with a compound B) which liberates isocyanic acid at this reaction temperature.

The preferred embodiments of this increase process are apparent from the description of the process for preparation of the high-molecular-weight polyamides. A preferred increase process is characterized by at least one of the characterizing features of claims 1 to 10.

### EXAMPLES

All of the pressures stated are absolute pressures. The following starting materials were used, and further properties of the polyamides are stated in table 1:
A1: Nylon-6, prepared using hexamethylenediamine as chain regulator; AEC>CEC
A2: Nylon-6, prepared using bis(hexamethylene)triamine as chain regulator; AEC>CEC
A3: Nylon-6, prepared using adipic acid as chain regulator; AEC<CEC (for comparison)
A4: Nylon-6, prepared using propionic acid as chain regulator; AEC<CEC (for comparison)
B: Urea, in the form of a 15% strength by weight solution in absolute ethanol
C: Copper(I) iodide in the form of concentrate composed of 95% by weight of nylon-6 and 5% by weight of CuI

The polyamide in the form of pellets was dried at 80° C. in vacuo (<100 mbar) to water content <0.1% by weight.

The urea was applied to the dried polymer pellets by applying the ethanolic urea solution at 25° C. to the pellets with some evaporation of the ethanol in a drum. The amount of the urea solution here was selected in such a way as to give the resultant pellets the urea content stated in table 1. The pellets thus treated were then dried for about 2 hours at 40° C. in vacuo (<100 mbar) in order to remove residues of adherent ethanol.

The urea-treated pellets—if appropriate together with an amount of the CuI concentrate such that the polymer comprised the amount stated in table 1 of CuI—were introduced into a Haake PTW 16 twin-screw extruder, in which the material was thoroughly mixed, and the mixture was extruded. The extruder temperature was 260° C., the screw rotation rate was 200 rpm, and the throughput was 1 kg/h.

The extruded high-molecular-weight polyamide was passed through a water bath and pelletized, and the pellets were dried at 80° C. in vacuo (<100 mbar) to water content <0.1% by weight.

The following properties were determined on the starting material polyamide A) and on the high-molecular-weight polyamide product:

Viscosity number VN: determined to ISO 307 EN on a 0.5% strength by weight solution of the polymer in 96% strength by weight sulfuric acid at 25° C.

Amino end group concentration AEC: 25 ml of a mixture composed of 75% by weight of phenol and 25% by weight of methanol were added to 1 g of the polymer and the mixture was boiled, with stirring and reflux, for 20 min. The mixture was then permitted to cool to 20° C., and 3 drops of an indicator solution (65 mg of benzyl orange and 35 mg of methylene blue dissolved in methanol and made up to 100 ml with methanol) were added. The mixture was then titrated with a 0.02 N solution of perchloric acid (1.72 ml of 70% strength perchloric acid mixed with 100 ml of methanol and made up to 1000 ml with ethylene glycol) until the color changed from green to red, and AEC was calculated from consumption of perchloric acid.

Carboxy end group concentration CEC: 25 ml of benzyl alcohol were added to 1 g of the polymer, and the mixture was boiled, with stirring, for 25 min under a vertical condenser, with nitrogen gas input. Six drops of an indicator solution (100 mg of kresol red dissolved in 100 ml of 1-propanol) were then added to the mixture while it was still hot, and the mixture was immediately titrated with a 0.02 N solution of potassium hydroxide (5.61 g of KOH dissolved in methanol and made up to 100 ml with methanol, 20 ml of this solution being made up to 1000 ml with 430 ml of 1-propanol and 550 ml of 1-hexanol) until the color changed from yellow to violet. CEC was calculated from consumption of KOH.

Volatile bases VBs: 100 ml of 10% strength by weight hydrochloric acid were added to 5 g of the polymer and the mixture was boiled for 4 hours under a vertical condenser. It was then cooled to 20° C. and the vertical condenser was replaced by a distillation bridge with dropping funnel. The receiver comprised 10 ml of 0.1 N hydrochloric acid, and the end of the distillation bridge tube here dipped into the hydrochloric acid. Within a period of 5 min, 70 ml of a 20% strength by weight sodium hydroxide solution were added dropwise and then 30 ml of the resultant mixture were distilled over into the receiver. The contents of the receiver were titrated with a few drops of an indicator solution (bromokresol red, 1% strength by weight in 20% strength by weight ethanol) and with a 0.1 N sodium hydroxide solution until the color changed from yellow to blue, and the content of volatile bases was calculated from NaOH consumption.

AEC, CEC, and VBs are stated in mmol per kg of polymer. Tables 1 and 2 give the compositions and the test results.

TABLE 1
Starting materials

| | | | | | | | Copper(I) |
|---|---|---|---|---|---|---|---|
| | Polyamide A | | | | Urea B²⁾ | | iodide C²⁾ |
| | | VN | AEC¹⁾ | CEC¹⁾ | [mmol/ | [% by | [% by |
| Ex. | | [ml/g] | [mmol/kg] | [mmol/kg] | kg] | weight] | weight] |
| 1c | A3 | 129 | 22 | 77 | 33 | 0.2 | — |
| 2c | A4 | 150 | 35 | 51 | 33 | 0.2 | — |
| 3c | A4 | 150 | 35 | 51 | 133 | 0.8 | — |
| 1 | A1 | 112 | 103 | 32 | 33 | 0.2 | — |
| 2 | A1 | 112 | 103 | 32 | 50 | 0.3 | — |
| 3 | A1 | 112 | 103 | 32 | 83 | 0.5 | — |
| 4 | A1 | 112 | 103 | 32 | 133 | 0.8 | — |
| 5 | A1 | 112 | 103 | 32 | 33 | 0.2 | 0.015 |
| 6 | A1 | 112 | 103 | 32 | 50 | 0.3 | 0.015 |
| 7 | A2 | 119 | 125 | 24 | 33 | 0.2 | — |
| 8 | A2 | 119 | 125 | 24 | 83 | 0.5 | — |

¹⁾AEC and CEC of polyamide A (prior to addition of urea B and copper(I) iodide C)
²⁾based on entirety of polyamide A + urea B + copper(I) iodide C

TABLE 2
Properties of resultant high-molecular-weight polyamide

| | VN | AEC | CEC | VBs |
|---|---|---|---|---|
| Ex. | [ml/g] | [mmol/kg] | [mmol/kg] | [mmol/kg] |
| 1c | 121 | 19 | 68 | 27 |
| 2c | 166 | 26 | 36 | 14 |
| 3c | 132 | 19 | 13 | 68 |
| 1 | 184 | 50 | 26 | 7 |
| 2 | 188 | 43 | 21 | 12 |
| 3 | 191 | 26 | 17 | 31 |
| 4 | 166 | 24 | 11 | 54 |
| 5 | 197 | 45 | 29 | 3 |
| 6 | 207 | 36 | 22 | 10 |
| 7 | 208 | 79 | 20 | nd |
| 8 | 267 | 44 | 13 | nd |

(nd: not determined)

The examples show that the inventive process can prepare high-molecular-weight polyamides in a very simple manner, in inventive examples 1-8, the viscosity number of the resultant polyamide was substantially higher than that of the polyamide used. In contrast, in the non-inventive examples (AEC<CEC in the polyamide used) only a small VN increase (example 2c) or indeed a fall in VN, i.e. a decrease in molecular weight, was observed (examples 1c, 3c).

Concomitant use of a copper compound could achieve particularly high molecular weights, as shown by comparing the otherwise identical examples 5 and 1 and, respectively, 6 and 2.

1-12. (canceled)

13. A process for increasing the molecular weight of polyamides which comprises:
reacting a polyamide A) at a temperature of from 150 to 350° C. with a compound B) which at this reaction temperature liberates isocyanic acid, or with isocyanic acid which is prepared separately via thermal decomposition of the compound B),
wherein the concentration of the amino end groups in the polyamide A) used is greater than or equal to the concentration of the carboxy end groups and the molar ratio of compound B) to the amino end groups of the polyamide is from 0.3:1 to 1.5:1, and
wherein at least 20 mol % of the polymer chains in the polyamide A) have two or more amino end groups.

14. The process according to claim 13, wherein the compound B) is selected from the group consisting of urea, biuret, triuret, cyanuric acid, silyl carbamate, trimethylsilyl carbamate, trimethylsilylurea, and poly(nonamethylene)urea.

15. The process according to claim 13 further comprising a copper compound C.

16. The process according to claim 13, wherein the amount of the copper compound C) is from 0.005 to 0.5% by weight, based on the entirety of components A), B), and C).

17. The process according to claim 13, wherein the reaction temperature is from 200 to 300° C.

18. The process according to claim 13, wherein the reaction takes place in an extruder.

19. The process according to claim 13, wherein the compound B) is applied to the solid polyamide A), and the resultant treated polyamide, optionally with the copper compound C), is mixed in the extruder at the reaction temperature, and the mixture is extruded.

20. The process according to claim 13, wherein the viscosity number of the high-molecular-weight polyamide obtained is from 150 to 300 ml/g, determined to ISO 307 EN on a 0.5% strength by weight solution in 96% strength by weight sulfuric acid at 25° C.

21. A high-molecular-weight polyamide obtainable by the process according to claim 13.

22. A method for production of moldings, foils, fibers, or foams comprising adding the high-molecular-weight polyamide according to claim 21 to a molding, a foil, a fiber or a foam formulation.

23. A molding, a foil, a fiber, or a foam composed of the high-molecular-weight polyamides produced according to the method claim 21.
